(19) United States
(12) Patent Application Publication
(10) Pub. No.: US 2010/0173131 A1
(43) Pub. Date: Jul. 8, 2010

(54) PHASE-SEPARATED COMPOSITE FOR MICROFLUIDIC APPLICATIONS

(75) Inventors: Roel Penterman, Eindhoven (NL); Reinhold Wimberger-Friedl, Eindhoven (NL); Ralph Kurt, Eindhoven (NL); Dirk Jan Broer, Eindhoven (NL); Emiel Peeters, Eindhoven (NL); Hendrik De Koning, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/377,173

(22) PCT Filed: Aug. 14, 2007
(86) PCT No.: PCT/IB07/53217

§ 371 Date: Feb. 11, 2009

(30) Foreign Application Priority Data
Aug. 15, 2006 (EP) 06118919.7

(51) Int. Cl. B32B 3/10; B05D 3/02

(52) U.S. Cl. 428/172; 427/385.5

(57) ABSTRACT

The invention relates to phase-separated composite for microfluidic applications, whereby the polymerization/phase separation is performed in such a way that a top-layer of a certain ratio to the height of the composite is achieved in order to ensure the stability of the composite.

The present invention is directed to the field of devices for microfluidic applications, such as e.g. chromatography of biomolecules.

Microfluidic devices play an important role for different applications, like in molecular diagnostic sensors. Typically, these devices contain channels with dimensions of less than one millimeter. Several technologies are used to manufacture such channel systems. Structured substrates are created by lithographic techniques in combination with etching and replication by molding or embossing. For the creation of channel systems the structured substrates must be combined with a cover in order to close the system. The cover must be bonded to the substrate very carefully to achieve sealing without disturbing the channel geometry. With decreasing channel dimensions the alignment and bonding process becomes more difficult, especially in the case of glue assisted bonding. Bonding conditions must be compatible with the biomaterials and particular surface treatments, which are present on the substrate. This limits the usefulness of bonding processes, such as thermal bonding.

A method of making such a device for microfluidic applications is e.g. disclosed in the US 2006/006006 A1, which is hereby fully incorporated by reference. It discloses a method for making a polymeric layer on a substrate comprising the steps of: a) forming a layer of a liquid comprising a photopolymerizable polymer precursor between the substrate and an at least partially transparent element; b) exposing the liquid layer to light through the at least partially transparent element, thereby polymerizing one or more regions of the liquid layer to form a polymeric layer; and c) removing any unpolymerized region or regions of the liquid layer.

A variety of similar methods is known in the art. However, all of these processes have the following disadvantages:

It is usually not possible to make a “sealed” channel, i.e. a channel which has a cover, in one step.

Virtually all of these methods involve a partial polymerization of a monomer, e.g. an (meth)acrylate, meth(meth)acrylate or epoxide monomer. The non-polymerized monomers must be removed. However, since these non-reacted monomers stay highly reactive, the process cannot be controlled and there is still the risk that highly-reactive species remain within the polymeric layer.

Often the step of removing sacrificial layers has to be seen as not environment friendly, as chemical waste is produced.

For a broad range of applications, usually only very low channel densities are obtained, for tightly sealed channels.

It is therefore an object of the present invention to provide a composite, which is able of at least partially overcoming some of the above-mentioned drawbacks and provides a use for microfluidic applications.

This object is solved by a composite according to claim 1 of the present invention. Accordingly, a polymeric phase-separated composite comprising at least one region which forms a channel-like structure whereby said region comprises at least one top layer provided with the channel and whereby the thickness t of the top layer (measured in the centre of the channel) is ≧250% and ≦90% of the height of the composite (measured in the centre of the channel).

According to the present invention, a channel especially means and/or includes a cavity, surrounded by a bottom substrate, side walls and a top/cover layer, in which a biological fluid can flow through, whereas the fluid can not flow through the substrate, the walls and the top/cover layer.

The channel might be open or partially or completely filled with solid or gel like material.

Moreover the term “channel” especially means and/or includes that the channel comprises a first short dimension (the channel width) and a second significantly longer dimension (the channel length).

By using such a composite, for most applications at least one of the following advantages can be achieved:

The composite is manufactured together with the “top layer” in one step thereby increasing the stability and making the manufacture easier.

Due to the phase separation, a greater percentage (in some applications close to 100%) of the polymerizable monomer can be used.

The manufacture of a phase-separated composite is known in the art, e.g. from the WO 2005/015295 and WO 02/42832 which are both hereby incorporated by reference.

However, these documents (and related documents) teach only the manufacture of closed compartments. It has shown in practice that the techniques disclosed in these documents are not applicable for the manufacture of channels and the composite will collapse when the liquid, which is used for the phase separation, is removed, or when a third liquid comprising e.g. a biological sample such as an analyte is filling the channel.

It has been found that especially capillary forces occurring at an interface between a gas and a liquid pulling the channel together with very strong forces resulting in altering the geometry of the channel or eventually even into stiction, i.e. an irreversible adhesion of the top-coat to the bottom substrate.

Surprisingly, the inventors have found out that a phase-separated composite comprising a region with a channel-like structure can be made under the proviso of claim 1. These structures are for most applications within the present invention found to be stable, even after removal of the auxiliary liquid which was used for the phase separation and may therefore be of use for microfluidic applications

According to an embodiment of the present invention, the thickness t of the top layer (measured in the centre of the channel) is ≧255% and ≦80% of the height of the composite (measured in the centre of the channel), more preferred ≧260% and ≦70%.

According to an embodiment of the present invention, the elastic modulus E of the top layer (after finishing the phase separation process) is E≧500 MPa (measured in dry state, especially after removing the auxiliary liquid). It has been shown within a wide range of application that this helps to further increase the stability of the structure.

According to an embodiment of the present invention, the elastic modulus E of the top layer (after finishing the phase separation process) is E≧1 GPa, according to an embodiment ≧5 GPa, according to an embodiment ≧10 GPa.

According to an embodiment of the present invention, the thickness of the top layer (after finishing the phase separation process) is t≧3 μm and ≦100 μm. By doing so, the composite is within a wide range of applications with the present invention further stabilized as well as the channel-like structure properly formed. According to an embodiment of the present invention, the thickness of the top layer (after finishing the phase separation process) is t≧5 μm and ≦70 μm, according to an embodiment ≧10 μm and ≦50 μm

According to an embodiment of the present invention, the width of the channel and/or the width between two pillaring elements in the channel is ≦300 μm. This, too, has been shown within a wide range of application that this helps to further increase the stability of the structure.

According to an embodiment of the present invention, the width of the channel and/or the width between two pillaring elements in the channel is ≦200 μm, according to an embodiment ≦100 μm, according to an embodiment ≦50 μm.

According to an embodiment of the present invention, the width of the channel wall (measured close to the substrate, i.e. at the place, where the wall is the thinnest) and/or the width of a pillaring element in the channel is ≧2 μm and ≦500 μm. This, too, has been shown within a wide range of application that this helps to further increase the stability of the structure, and to improve the sealing but allowing a high channel density.

According to an embodiment of the present invention, the width of the channel wall and/or the width of a pillaring element in the channel is ≧5 μm and ≦100 μm, according to an embodiment ≧10 μm and ≦50 μm.

According to an embodiment of the present invention, the composite is provided on a substrate with the channel having a contact angle α of ≧1 and ≦40°, preferably ≧2° and ≦30° and most preferred ≧5° and ≦20°. According to an embodiment of the present invention, the composite comprises ≧10 channels per mm², preferably ≧20, more preferably ≧50 and most preferred ≧100 per mm²

According to an embodiment of the present invention, the ratio of the average width of the channel to the average width of the walls between two channels is ≧1:1 and ≦20:1. By doing so, a more compact composite can be provided for a wide range of applications within the present invention. Preferably, the ratio of the average width of the channel to the average width of the walls between two channels is ≧2:1 and ≦10:1, more preferred ≧3:1 and ≦8:1.

According to an embodiment of the present invention, the composite comprises a poly(meth)acrylic material

According to an embodiment of the present invention, the composite comprises a poly(meth)acrylic material made out of the polymerization of at least one (meth)acrylic monomer and at least one polyfunctional (meth)acrylic monomer.

According to an embodiment of the present invention, the (meth)acrylic monomer is chosen out of the group comprising (meth)acrylamide, (meth)acrylic acid, hydroxyethyl(meth)acrylate, ethoxyethoxyethyl(meth)acrylate hydroxyethylmeth(meth)acrylate, isobornyl(meth)acrylate, isobornyl meth(meth)acrylate or mixtures thereof.

According to an embodiment of the present invention, the polyfunctional (meth)acrylic monomer is a bis-(meth)acryl and/or a tri-(meth)acryl and/or a tetra-(meth)acryl and/or a penta-(meth)acryl monomer.

According to an embodiment of the present invention, the polyfunctional (meth)acrylic monomer is chosen out of the group comprising bis(meth)acrylamide, tripropyleneglycol di(meth)acrylates, pentaerythritol tri(meth)acrylate polyethyleneglycol di(meth)acrylate, ethoxylated bisphenol-A-di(meth)acrylate or mixtures thereof.

According to an embodiment of the present invention, the crosslink density in the poly(meth)acrylic material is ≧0.05 and ≦1.

In the sense of the present invention, the term “crosslink density” means or includes especially the following definition: The crosslink density δ_{X} here is defined as

$${δ}_{X} = \frac{X}{L + X}$$

where X is the mole fraction of polyfunctional monomers and L the mole fraction of linear chain (=non polyfunctional) forming monomers. In a linear polymer δ_{X}=0, in a fully crosslinked system δ_{X}=1.

According to an embodiment of the present invention, the composite further comprises at least one region whereby a nanoporous and/or gel material is provided in and/or with the channel-like structure.

According to an embodiment of the present invention, the gel material is a hydrogel.

This nanoporous and/or gel material may be applied in various way, including:

After the provision of the composite via a phase separation together with a polymerization, the auxiliary liquid (which is now in the channel-like structure) may be removed and the channel may be filled again with a second reaction mixture that forms a nanoporous or a gel structure upon polymerization. Optionally the porous or gel structure may be patterned by means of a mask illumination.

However, it is also feasible to use as an auxiliary liquid a mixture of a solvent and a (third) precursor material which is capable of being transformed into the desired shape and/or properties (e.g. by polymerization, gelation etc.) after the formation of the channel-like structure. In this regard, it is preferred that the (third) precursor material is either a reactive precursor selected out of the group epoxides (e.g. hydroxyethylglycidylether), oxetanes or vinylethers in combination with a suitable cationic photoinitiator such as diaryliodonium salts, triarylsulphonium salts, phenylacylsulphonium salt or alkoxypyridinium salts or mixtures thereof, or the (third precursor is a non-reactive low molecular weight gelator selected out of the group of fatty acid derivatives (e.g. hydroxyoctadecanoic acid), long n-alkanes, steroid derivatives, anthryl derivatives, sorbitol and polyol derivatives, bisurea and bisurethane derivatives, organometalic compounds and bicomponent gelators or mixtures thereof. It preferred that the solvent is selected out of the group comprising water or hydrocarbons, especially selected out of the group comprising decane, cyclohexane, xylene, ethanol or mixtures thereof. These materials have proven themselves in practice to be of use within a wide range of applications with the present invention.

The present invention furthermore relates to a method of providing a composite according to the present invention, comprising the steps of:

a) forming a layer of a liquid comprising a first polymerizable polymer precursor material, a second auxiliary liquid material and at least one photoabsorber material
b) causing the first polymerizable polymer precursor material to polymerize in order to form a polymeric layer; and
c) during or after step b) causing a phase separation of the polymer material and the second auxiliary liquid material

According to an embodiment of the present invention, the at least one photoabsorber material has a extinction ε of ≧5000 l mol⁻¹ cm⁻¹ and ≦40000 l mol⁻¹ cm⁻¹ at the wavelengths of irradiation. Furthermore it is especially preferred that the at least one photoabsorber material is present in such a concentration that the absorption of a layer with a height of 1 μm is ≧0.05 and ≦1.5.

According to an embodiment of the present invention, the layer of liquid is provided on a substrate material, whereby the substrate material is preferably a glass material.

According to an embodiment of the present invention, the liquid forming the auxiliary liquid layer has a contact angle with the substrate of θ≦π/2, preferably ≦60°, more preferably ≦45°, most preferably ≦30°. This allows for a wide range of applications within the present invention an easy processing of the layer.

According to an embodiment, the formation of layer is achieved by doctor blading or knife coating and/or spin coating.

According to an embodiment of the present invention, the first polymerizable polymer precursor material is a photopolymerizable material, preferably an (meth)acrylic material.

The term “(meth)acrylic material” especially means and/or includes at least one (meth)acrylic monomer and at least one polyfunctional (meth)acrylic monomer as described above.

According to an embodiment of the present invention, there is also provided a mask pattern and/or an at least partially transparent element in order to form the at least one channel-like structure. The polymerization is then achieved by exposing the liquid layer to light through the at least partially transparent element and/or the mask pattern, thereby polymerizing one or more regions of the liquid layer to form a polymeric layer of the first polymerizable polymer precursor material.

According to an embodiment of the present invention, the composite is provided at least partly according to the following method:

a) forming a layer of a liquid comprising a first polymerizable polymer precursor material, a second auxiliary liquid material and at least one photoabsorber material.
b) causing the first polymerizable polymer precursor material to polymerize in the sections of the composite, where walls are to be created, preferably with the aid of a mask pattern and/or an at least partially transparent element;
c) after the formation of the “walls”, causing the first polymerizable polymer precursor material to polymerize in order to form a polymeric layer; and
d) during or after step c) causing a phase separation of the polymer material and the second auxiliary liquid material in order to create a channel.

The formation of channels is in this particular method provided due to the fact that a photoabsorber is present in the liquid layer. When illuminated from above, the photoabsorber will decrease the polymerization speed in the lower regions of the liquid layer; therefore the polymerization will essentially occur in the top regions of the liquid layer. In the course of the polymerization, a phase separation then occurs, which will cause the formation of the channel, as will be described later on.

This particular method is furthermore explained in great detail in the U.S. Pat. No. 6,818,152 and cited literature therein which is fully incorporated by reference.

According to an embodiment of the present invention, the composite is provided at least partly according to the following method:

a) forming a layer of a liquid comprising a first polymerizable polymer precursor material, a second auxiliary liquid material and at least one photoabsorber material on a substrate material with a surface which comprises at least one region with a high affinity for said first polymerizable material and at least one region with a low affinity for said first polymerizable material
b) causing the first polymerizable polymer precursor material to polymerize
c) during or after step b) causing a phase separation of the polymer material and the second auxiliary liquid material in order to create a channel.

In this method, the general principle of the formation of channels is essentially identical to that of the method shown above. Indeed, it should be expressively noted that a skilled artisan will see that both methods may be combined ad lib. if useful for an application within the present invention.

However, the formation of “walls” is in this method predominately to the fact that the substrate material has been “pre-arranged” having region(s) with a high affinity for said first polymerizable material and region(s) with a low affinity for said first polymerizable material. In said regions with a high affinity, the polymerization will be enhanced, leading to a “wall”, whereby in said second region, the phase-separation will cause for “channels” to be formed. Therefore, a mask may be omitted.

This method is furthermore described in great detail in the WO 2005/015295 and literature cited therein, which is hereby fully incorporated by reference.

According to an embodiment of the present invention, the liquid layer furthermore comprises a photoinitiator material in order to enhance the polymerization of the first polymerizable polymer precursor material. It is clear to any skilled person in the art that the formation of the at least one channel-like structure may also be directed by varying the concentration of the photoinitiator material within the liquid layer.

Preferably, the photoinitiator material is selected out of the group comprising diazomaterials, especially AIBN, peroxides, benzyldimethyl-ketal, optionally admixed with photoinitiator adjuvants such as amines, or mixtures of these compounds.

According to an embodiment of the present invention, the liquid layer furthermore comprises a photoinhibitor material in order to inhibit or decrease the polymerization of the first polymerizable polymer precursor material especially in regions, where the composite is to form the at least one channel-like structure.

Preferably, the photoinhibitor material is selected out of the group comprising disulfides, chinones, nitroso compounds, phenols, thiophenols and mixtures thereof.

According to an embodiment of the present invention, the second auxiliary liquid material is selected out of the group comprising water, hydrocarbons, especially selected out of the group comprising decane, cyclohexane, xylene, ethanol or mixtures thereof. These materials have proven themselves in practice to be of use within a wide range of applications with the present invention.

According to an embodiment of the present invention, the elastic modulus E of the top layer before the beginning of step c) is E≦1 GPa, according to an embodiment ≦100 MPa, according to an embodiment ≧10 MPa. In most applications within the present invention, the inventors have found that the phase separation (step c) will take place when at least some of the top layer has already been formed. Within a wide range of applications, the inventors have found that by keeping the elastic modulus E of the top layer in this stage as described, the channel-like structure will be formed in a proper-shaped manner.

However, it should be noted that in the final composite the elastic modulus E of the top layer will most likely be higher, e.g. as described above.

According to an embodiment, as described above, the composite further comprises at least one region whereby a nanoporous and/or gel material is provided in and/or with the channel-like structure. Thus, according to one embodiment of the present invention, the method furthermore comprises at least one step for providing such at least one region according to one or more of the following procedures:

Providing a further (e.g. third) precursor material which does not or only to a small content polymerize during the formation of the channels and walls, which is then subsequently polymerized and/or otherwise chemically changed to form the nanoporous structure and/or the gel.

Providing the further precursor material in form of a further polymerizable material whose polymerization can be initiated in a wavelength region where the at least one photoabsorber is transparent and/or essentially transparent. By doing so, it is possible to polymerize the further polymerizable material after the formation of the channels and walls.

Providing the further precursor material in form of low molecular weight gelators, preferably selected out of the group of fatty acid derivatives (e.g. hydroxyoctadecanoic acid), long n-alkanes, steroid derivatives, anthryl derivatives, sorbitol and polyol derivatives, bisurea and bisurethane derivatives, organometalic compounds and bicomponent gelators or mixtures thereof which are gelated subsequently to the formation of channels

Using kinetic differences (i.e. by change of temperature) between the polymerization of the first polymerizable material and polymerization and/or gelation of the further precursor material. A suitable example, which is insofar a preferred embodiment of the present invention is e.g. to use (meth)acrylates as the first polymerizable material and epoxy materials such as 2-hydroxy-ethyl-glycidyl-ether for the (third) precursor material. The polymerization of the (meth)acrylate is in most applications much faster, therefore the epoxy materials will in most applications polymerize after formation of the channels and walls.

Using the difference in solvation and/or polarity between the initial liquid layer (which comprises the first polymerizable material, the second auxiliary liquid and the further (third) precursor material) and the liquid material that is present in the channels after formation of the channels and walls and will comprise essentially only the second auxiliary liquid and the further (third) precursor material.

In the latter context, it is a preferred embodiment to use a polymerization and/or gelation reaction which is inhibited or hindered by the first polymerizable material. After “removal” of this material by polymerization, a polymerization and/or gelation reaction of the further (third) precursor material may occur.

According to a preferred embodiment of the present invention, the further (third) precursor material is chosen out of the group epoxides, oxetanes or vinylethers in combination with a suitable cationic photoinitiator such as diaryliodonium salts, triarylsulphonium salts, phenylacylsulphonium salt or alkoxypyridinium salts, or mixtures thereof.

According to an embodiment of the present invention, further layers might be added onto the layer formed out of the first material, especially to increase the stiffness of the composite. These layers may also be made by any of the suitable methods described above, e.g. by polymerization, either thermally or photochemically.

A composite, a method and/or device according to the present invention may be of use in a broad variety of systems and/or applications, amongst them one or more of the following:

biosensors used for molecular diagnostics

rapid and sensitive detection of proteins and nucleic acids in complex biological mixtures such as e.g. blood or saliva

high throughput screening devices for chemistry, pharmaceuticals or molecular biology

testing devices e.g. for DNA or proteins e.g. in criminology, for on-site testing (in a hospital), for diagnostics in centralized laboratories or in scientific research

tools for DNA or protein diagnostics for cardiology, infectious disease and oncology, food, and environmental diagnostics

tools for combinatorial chemistry

analysis devices.

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

### BRIEF DESCRIPTION OF THE DRAWINGS

Additional details, features, characteristics and advantages of the object of the invention are disclosed in the subclaims, the figures and the following description of the respective figures and examples, which—in an exemplary fashion—show several preferred embodiments of a separation medium as well as a device according to the invention.

FIG. 1 shows a very schematic cross-sectional partial view showing composite having a channel-like structure according to a first embodiment of the present invention equivalent to a view along line II-II in FIG. 4.

FIG. 2 shows a very schematic cross-sectional view of a substrate, a liquid layer and a mask pattern prior to the formation of a composite according to a second embodiment of the present invention.

FIG. 3 shows a very schematic cross sectional view according to FIG. 2 after the first polymerization step.

FIG. 4 shows a very schematic cross sectional view according to FIG. 2 during the second polymerization step indicating the phase separation.

FIG. 5 shows a very schematic top view of a liquid layer and several mask patterns for forming a plurality of channel-like structures according to an embodiment of the present invention.

FIG. 6 shows a very schematic cross-sectional partial view showing a composite having a channel-like structure with according to a first embodiment of the present invention equivalent to a view along line II-II in FIG. 5 with a multitude of channels.

FIG. 7 shows a very schematic partial top view of a liquid layer and a first mask pattern for providing a channel-like structure with a nanoporous material according to a further embodiment of the present invention.

FIG. 8 shows a very schematic partial top view of a composite manufactured out of the liquid layer in FIG. 5 and a second mask pattern prior to the providement of the nanoporous material.

FIG. 9 shows a very schematic partial top view of a composite manufactured out of the liquid layer in FIG. 5 and an alternative mask pattern prior to the provision of the nanoporous material.

FIG. 10 shows a very schematic partial top view the ready composite having a channel-like structure and a section with a nanoporous material.

FIG. 11 shows a very schematic perspective view of a pilloring element for use within a channel-like structure of a composite according to a further embodiment of the present invention.

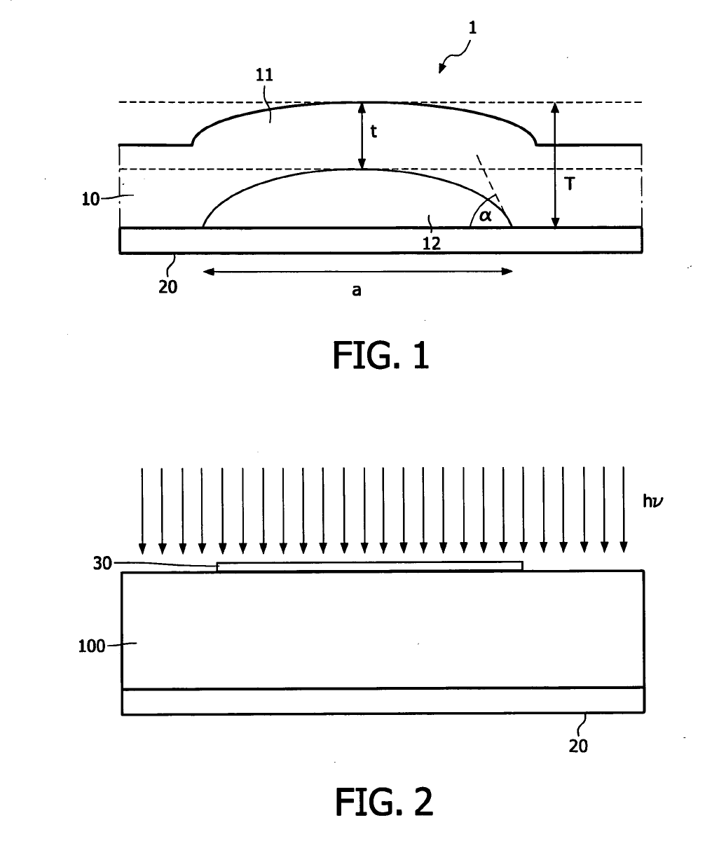

FIG. 1 shows a very schematic cross-sectional partial view showing composite 1 having a channel-like structure according to a first embodiment of the present invention equivalent to a view along line II-II in FIG. 4. The composite comprises a poly(meth)acrylic material 10 which is provided on a substrate 20. The ratio of the height of the top layer (measured in the centre of the channel) as indicated by “t” to the ratio of the height of the composite (measured in the centre of the channel) as indicated by “T” is as described above.

Although FIG. 1 is highly schematic, it can be seen that the channel-like structure has not a square cross section, but rather a semi-elliptic cross section. Actually, the inventors have found that in practice most composites which are made according to the invention will employ a similar structure like that of FIG. 1.

Furthermore, the angle α (as indicated in FIG. 1) is preferably as described above, which may lead to further stability for a wide range of applications within the present invention.

FIG. 2 shows a very schematic cross-sectional view of a substrate 20, a liquid layer 100 and a mask pattern 30 prior to the formation of a composite according to a second embodiment of the present invention. The liquid layer comprises a mixture of a first polymerizable polymer precursor material (in the particular embodiment an (meth)acrylic material), a second auxiliary liquid material, which is in the particular embodiment a hydrocarbon such as xylene and a photoabsorber material (which becomes important in the step seen in FIG. 4).

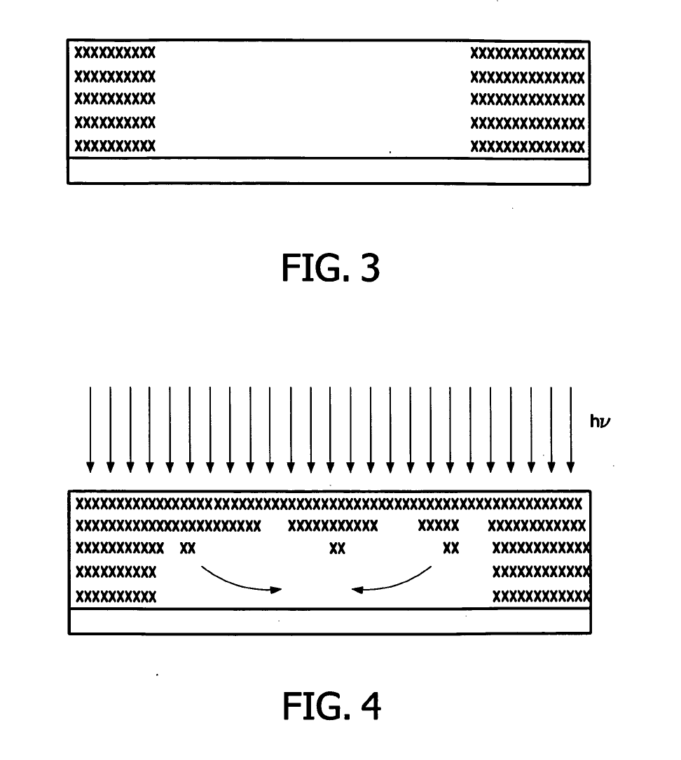

FIG. 3 shows a very schematic cross sectional view according to FIG. 2 after the first polymerization step. As indicated by the “x”, the part of the liquid layer, where no mask pattern was applied, was photopolymerized to form walls.

FIG. 4 shows a very schematic cross sectional view according to FIG. 2 after the initiation of the second polymerization, indicating the way of the phase-separation. When illuminated from above, the photoabsorber will decrease the polymerization speed in the lower regions of the liquid layer simply due its absorption capabilities, which diminishes the amount of light that is able to reach these lower regions.

For this reason the polymerization will essentially occur in the top regions of the liquid layer. In the course of the polymerization, a phase separation will occur (as indicated by the arrows) which then leads to the formation of walls. The inventors have found out that the actual phase separation will in most applications of the present invention occur when the polymerization is nearly finished.

It should be noted that the process in FIGS. 2 to 4 is highly schematic and for details, the skilled artisan should e.g. refer to the U.S. Pat. No. 6,818,152 and cited literature therein.

The FIGS. 2 to 4 furthermore show only one feasible process of the formation of the composite. The skilled artisan will easily see that also a process according to the WO 2005/015295 (or an ad lib combination of the two processes) may be used for the formation of the composite.

It should be noted that if the ratio of “t” and “T” are chosen according to the present invention, the auxiliary liquid may in utmost all applications of the present invention be removed without deterioration of the polymeric regions of the composite. Therefore the composite and the method of making the same according to the invention allow the formation of channel-like structures which are covered in one step.

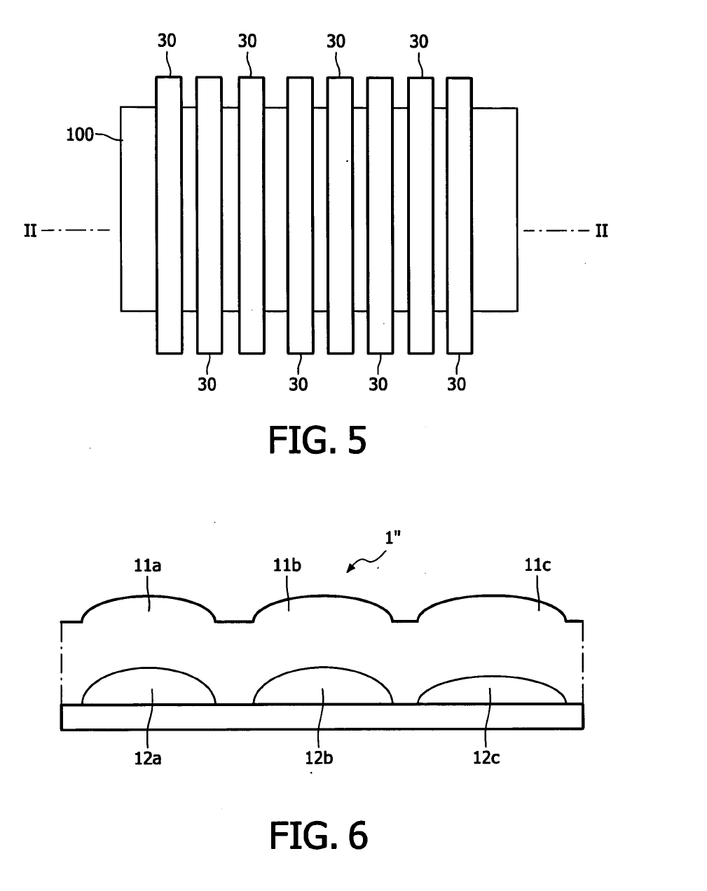

FIG. 5 shows a very schematic top view of a liquid layer 100 and several mask patterns 30 for forming a plurality of channel-like structures according to an embodiment of the present invention. From FIG. 4 it can be clearly seen that several channel-like structures may be provided in a single polymerizing and phase-separating process.

FIG. 6 shows a very schematic cross-sectional partial view showing a composite having a channel-like structure with according to a first embodiment of the present invention equivalent to a view along line II-II in FIG. 5 with a multitude of channels. Although FIG. 6 is highly schematic as well, it can be seen that a composite according to the present invention may have channels with only a relative small wall between them; actually the ratio of the channel width to the wall width between to channels is preferably as described above.

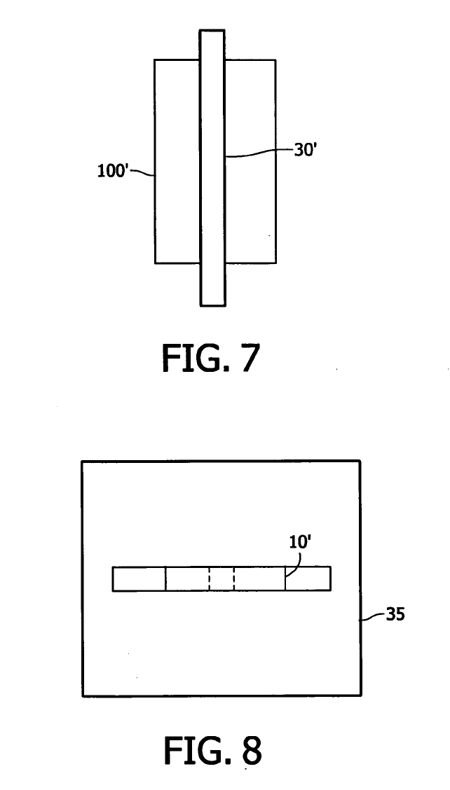

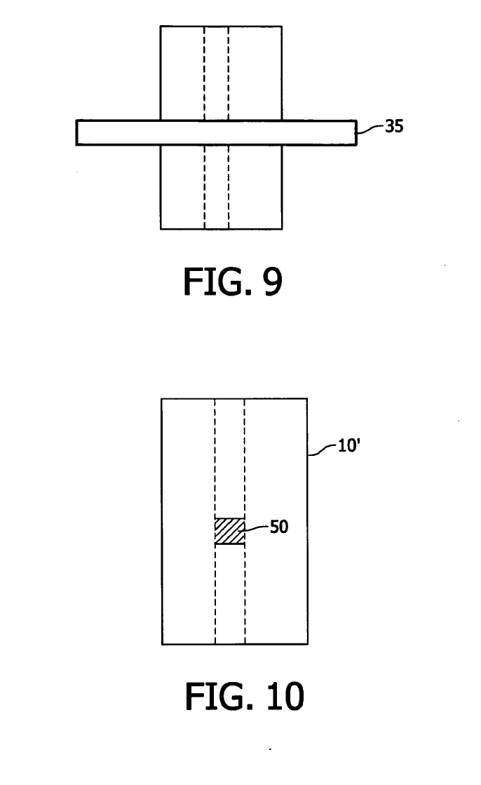

FIGS. 7 to 10 show the manufacture of a composite 10′ according to a further embodiment of the present invention which not only comprises a channel-like structure but also a region 50, where the channel-like structure is provided with a nanoporous and/or gel material. It should be noted that FIGS. 8 and 9 show two alternatives.

The process as shown in FIGS. 7 to 10 is a three-step process; however, it is also possible to derive the structure of FIG. 10 in a more or less concerted process as described above.

In FIGS. 7 and 8, a channel-like structure is made using the liquid layer 100′ and the first mask pattern 30′ as already described. However, in FIG. 8, a second mask pattern 35 is employed and a second process, e.g. a second polymerization is started, which then leads to the region 70, which comprises a nanoporous and/or gel material.

FIG. 9 shows a very schematic partial top view of a composite manufactured out of the liquid layer in FIG. 5 and an alternative mask pattern prior to the provision of the nanoporous material. In this figure, the mask pattern is somewhat the “negative” of that of FIG. 8.

In this particular embodiment, the formation of a nanoporous region is achieved the following way:

In this further step, the areas where the channels will formed are slightly irradiated but not fully polymerized. Again polymerisation-induced diffusion takes place, increasing the amount of auxiliary liquid in area 50. Then in a third UV step the sample is flood exposed with light that is partly absorbed by the photoabsorber.

The inventors have found out that in areas, where the concentration of the auxiliary liquid is high (which will be the area covered by the mask pattern in FIG. 9), a nanoporous region will be formed. In regions where the concentration is lower (i.e. the regions not covered by the mask pattern in FIG. 9 but initially covered by the mask pattern in FIG. 7) a channel is formed.

In both FIGS. 8 and 9, this second process involves a further polymerization, however, it is clear to a skilled artisan that also a broad variety of further processes, including those described above, may be used.

It should also be noted that between the first polymerization and the second process, the auxiliary liquid of the first polymerization may be removed and be replaced by a second liquid, out of which then region 70 is formed. However, it is clear to the skilled artisan, that—if the auxiliary liquid is properly chosen—this is not needed and both processes may be performed without such a removal, e.g. if further precursor components are also present in the initial liquid layer.

It should furthermore be noted that due to the fact that the phase separation in most applications occurs quite at the end of the polymerization, it is possible to perform both steps concerted, i.e. that the mask pattern 30′ is removed before the end of the polymerization/phase-separation step and the second process (as indicated in FIGS. 8, 9 and 10) is simultaneously with the completion of the polymerization/phase-separation.

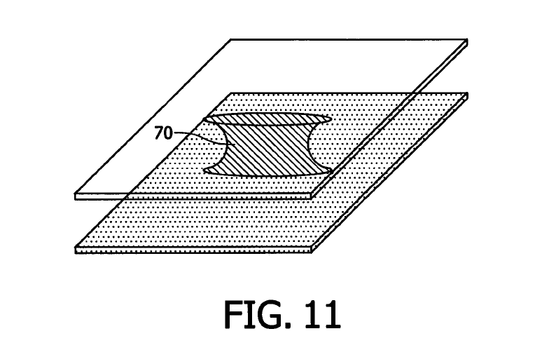

FIG. 11 shows a very schematic perspective view of a pillaring element 70 for use within a channel-like structure of a composite according to a further embodiment of the present invention. As described above, it is for some applications within the present invention preferred that the width of the channel becomes not too wide. However, wider channel structures may be achieved by introducing such pillaring elements, one example being the pillaring element 70 of FIG. 11. By doing so, the stability of the composite may be maintained in these applications.

The pillar can e.g. be made using one or both of the following processes:

either with a mask, illuminating the pillar area in the first illumination step,

or depositing a single dot of adhesion promoter at the location, where the pillar has to be formed.

The particular combinations of elements and features in the above detailed embodiments are exemplary only; the interchanging and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

1. A polymeric phase-separated composite comprising at least one region which forms a channel-like structure whereby said region comprises at least one top layer provided with the channel and whereby the thickness t of the top layer is between ≧50% and ≦90% of the height of the channel.

2. The composite according to claim 1, whereby the elastic modulus E of the top layer after finishing the phase separation process is E≧100 MPa.

3. The composite according to claim 1, whereby the width of the channel and/or the width between two pillaring elements in the channel is ≦300 μm.

4. The composite according to claim 1, whereby the separation medium comprises a poly(meth)acrylic material.

5. The composite according to claim 1, whereby the crosslink density of the poly(meth)acrylic material is ≧0.0001 and ≦0.5.

6. A composite according to claim 1, whereby the composite further comprises at least one region whereby a nanoporous and/or gel material is provided in and/or with the channel-like structure.

7. A method of producing a composite, especially according to claim 1 comprising the steps of
a) forming a layer of a liquid comprising a first polymerizable polymer precursor material and a second auxiliary liquid material and at least one photoabsorber material
b) causing the first polymerizable polymer precursor material to polymerize in order to form a polymeric layer; and
c) during or after step b) causing a phase separation of the polymer material and the second auxiliary liquid material.

8. A method according to claim 7, whereby the first polymerizable polymer precursor material is a photopolymerizable material, preferably an (meth)acrylic material.

9. A method according to claim 7 whereby the second auxiliary liquid material is selected out of the group comprising hydrocarbons, especially selected out of the group comprising decane, cyclohexane, xylene or mixtures thereof; water, ethanol or mixtures thereof.

10. A system incorporating a composite according to claim 1, and being used in one or more of the following applications:
biosensors used for molecular diagnostics
rapid and sensitive detection of proteins and nucleic acids in complex biological mixtures such as e.g. blood or saliva
high throughput screening devices for chemistry, pharmaceuticals or molecular biology
testing devices e.g. for DNA or proteins e.g. in criminology, for on-site testing (in a hospital), for diagnostics in centralized laboratories or in scientific research
tools for DNA or protein diagnostics for cardiology, infectious disease and oncology, food, and environmental diagnostics
tools for combinatorial chemistry
analysis devices.
